(19) United States
(12) Patent Application Publication
(10) Pub. No.: US 2012/0204483 A1
(43) Pub. Date: Aug. 16, 2012

(54) Solid waste reclamation process

(75) Inventors: Ronald H. Van den Heuvel, De Pere, WI (US); Daniel Platkowski, Oneida, WI (US)

(73) Assignee: PC Fibre Technology, LLC, De Pere, WI (US)

(21) Appl. No.: 13/385,218

(22) Filed: Feb. 8, 2012

Related U.S. Application Data
(60) Provisional application No. 61/441,825, filed on Feb. 11, 2011.

(51) Int. Cl. C10L 5/40; C01B 31/02; D21C 5/02

(52) U.S. Cl. 44/605; 162/4; 162/5; 423/461

(57) ABSTRACT

A process for reclaiming food-contaminated solid waste streams from fast food restaurants, casual dining restaurants, cafeterias, schools, colleges and universities, concession stands, arenas, stadiums, movie theaters, large city street trash bins and other entertainment venues, and other places that offer simple food items for dine in or carry-out that are currently sent to a land fill. The inventive process offers total solid waste reclamation with zero waste water discharge, zero landfill and minor source air emissions, resulting in 100% reclamation and a 100% sustainable process. This process can also be used on solid waste from reclamation centers and manufacturers who currently land fill their waste.

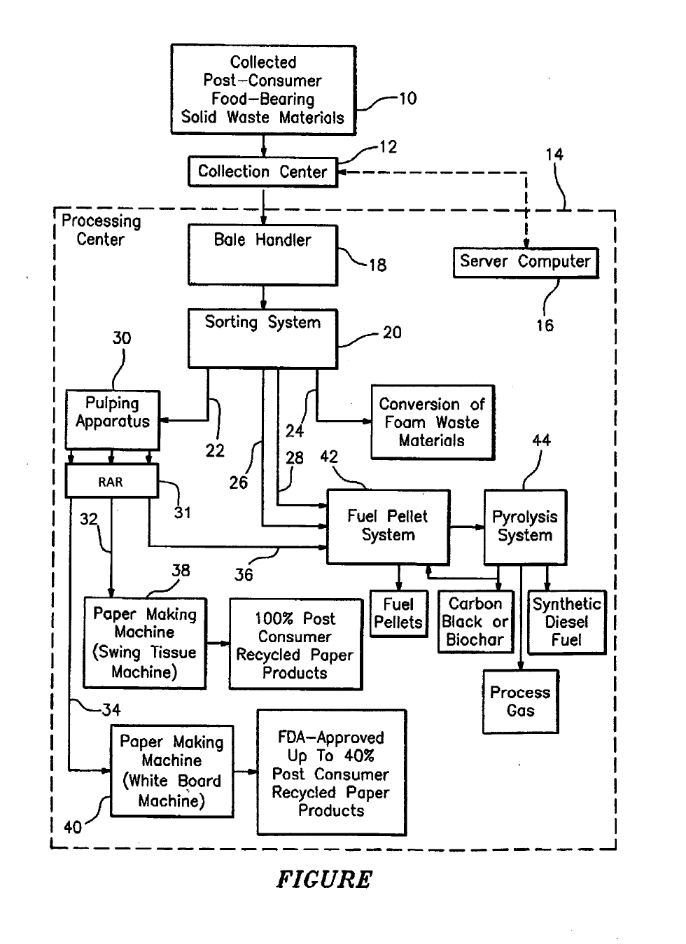

### CROSS-REFERENCE TO RELATED APPLICATIONS

This application claims the benefit of Provisional Patent Application Ser. No. 61/441,825 filed on Feb. 11, 2011 by the present inventors.

### TECHNICAL FIELD OF THE INVENTION

The present invention generally relates to a solid waste reclamation process, and more particularly relates to a process for reclaiming solid waste from waste streams of fast food restaurants, casual dining restaurants, cafeterias, schools, colleges and universities, concession stands, arenas, stadiums, and other entertainment venues, and other places that offer simple food items for dine in or carry-out. This process can also be used on solid waste from reclamation centers and manufacturers who currently land fill their waste. The inventive process offers total solid waste reclamation with zero waste water discharge, zero landfill and minor source air emissions, resulting in 100% reclamation and a 100% sustainable process

### BACKGROUND AND SUMMARY OF THE INVENTION

Restaurants, cafeterias, concession stands and other places offering simple food items for dine in or carry-out produce millions of pounds of waste per year. This waste comes in several forms including plastic eating utensils, Styrofoam® cups and containers, food wrappers and napkins.

Currently there are limited federal state, and local laws or regulations in the U.S. requiring such establishments to reduce, reuse or recycle their waste. While a small number of cities and towns have local laws specifically designed to force businesses to recycle a portion of their waste, they are few and far between.

Moreover, recycling food-bearing waste is complex in nature, the cost is steep and many cities simply don't have the resources to accomplish it. As such, collected fast food-bearing waste is typically landfilled or released in effluent water. Landfill costs are increasing as space becomes limited and the costs of developing them with the required environmental protections to avoid leaching and odors are continually increasing.

In view of the above, there is a need for a cost-effective way for these establishments to recycle food-bearing waste.

The present invention offers such a cost-effective way to recycle food-bearing waste allowing generators of these solid waste streams to advertise environmental sustainability and to certify 100% reclamation of their solid waste streams. In particular, the present invention provides a process for reclaiming solid waste from waste streams of fast food restaurants, casual dining restaurants, cafeterias, schools, colleges and universities, concession stands, arenas, stadiums, and other entertainment venues, and other places that offer simple food items for dine in or carry-out, the process comprising:

collecting post consumer solid waste materials including, but not limited to, plastic-free and wax-free paper waste materials (e.g., paper plates, paper napkins, paper cups, paper placemats, paper tablecloths, paper bags, paper towels), plastic-coated paper waste materials (e.g., plastic-coated paper cups, milk cartons, juice cartons, ice cream containers, food packaging materials), foam (i.e., Styrofoam® extruded polystyrene foam) waste materials (e.g., foam drinking cups, foam lids, foam food containers), and plastic waste materials (e.g., plastic utensils, plastic cups and plates, plastic straws, lids, bottles and packaging materials) wherein the post consumer solid waste materials further include a first organic waste material stream containing organic waste (e.g., food), sludge and raw wastewater;

separating the collected consumer solid waste materials into one or more foam waste material streams, one or more paper waste material streams, one or more plastic waste material streams, and the first organic waste material stream;

converting (or arranging for the conversion of) the foam waste materials in the one or more foam waste material streams into recycled foam products;

subjecting the paper waste materials in the one or more paper waste material streams to a manufacturing process for forming brown and white paper pulp for sanitary tissue and other paper products, white paper pulp for beverage cups, and a second organic waste material stream containing organic waste, plastic from the plastic-coated paper waste materials, sludge, inks, and raw wastewater, and separating these product streams;

conducting the following optionally simultaneous operations:
directing the brown and white paper pulp to one or more machines for making recycled paper products including jumbo (parent) rolls of paper and tissue-paper, paper napkins and paper towels, and for making tissue-paper products including facial tissue and bath tissue;
directing the white paper pulp to one or more machines for making FDA-approved recycled paper products (e.g., drinking cups); and
directing the one or more plastic waste material streams and the first and second organic waste material streams to a system for producing fuel pellets, pyrolyzing at least a portion of the fuel pellets produced by the fuel pellet production system to make carbon black or biochar, process gas, and synthetic diesel fuel, heavy oils, and/or lubricants, with the option of converting a portion of the process gas and/or synthetic diesel fuel into electricity, and directing at least a portion of the carbon black or biochar back into the fuel pellet production system.

The present invention also provides a self-contained system for reclaiming solid waste from the waste streams identified above, the system comprising:

means for separating collected post consumer solid waste materials into one or more plastic-free and wax-free paper waste material streams, one or more plastic-coated paper waste material streams, one or more foam waste material streams, one or more plastic waste material streams, and a first organic waste material stream comprising organic waste, sludge, and raw wastewater;

means for converting (or arranging for the conversion of) the foam waste materials in the one or more foam waste material streams into recycled foam products;

means for producing chemical pulp (and a second organic waste material stream) from the paper waste materials in the paper waste material streams, the chemical pulp comprising brown and white paper pulp and white paper pulp, the second organic waste material stream comprising organic waste, plastic from the plastic-coated paper waste materials, sludge, inks, and raw wastewater;

one or more paper-making machines for making paper and tissue-paper products from the chemical pulp, the paper products including jumbo (parent) rolls of paper and tissue-paper, paper napkins, paper towels, and FDA-approved, post consumer paper products (e.g., paper cups), and the tissue-paper products including facial tissue and bath tissue;

a fuel pellet production system for producing fuel pellets from the one or more plastic waste material streams and the first and second organic waste material streams;

a pyrolysis system and/or liquefaction system for converting at least a portion of the produced fuel pellets to make carbon black and biochar, process gas, synthetic diesel fuel lubricants, or other saleable hydrocarbons;

means for directing at least a portion of the carbon black and biochar, process gas, and synthetic diesel fuel to one or more components of the system to power these components; and

one or more generators for powering other components in the self-contained system, the generators being powered by the process gas or synthetic diesel fuel produced by the pyrolysis system.

Also provided by way of the present invention are paper or tissue products made entirely from post consumer solid waste materials.

Other features and advantages of the invention will be apparent to one of ordinary skill from the following detailed description and accompanying drawings.

Unless otherwise defined, all technical and scientific terms used herein have the same meaning as commonly understood by one of ordinary skill in the art to which this invention belongs. All publications, patent applications, patents and other references mentioned herein are incorporated by reference in their entirety. In case of conflict, the present specification, including definitions, will control. In addition, the materials, methods, and examples are illustrative only and not intended to be limiting.

### BRIEF DESCRIPTION OF THE DRAWING

The FIGURE is a schematic process flow diagram depicting the main features of the process for reclaiming solid waste from food-bearing waste streams of the present invention.

### BEST MODE FOR CARRYING OUT THE INVENTION

By way of the present invention, food-bearing waste streams that were previously sent to landfills are transformed into recycled paper, tissue-paper, and foam products, fuel pellets, carbon black or biochar, process gas, synthetic diesel fuel, and electricity, the result being that none of the collected waste materials goes to a landfill or is released in effluent water. By collecting these waste materials and processing them back into recycled items (under a minor source air permit and the other necessary operating permits), there is a savings to the consumer and to the waste-generating business entity, as well as an overall reduction in environmental impact.

The inventive system consumes less electricity, fuel, water, and chemicals than known manufacturing and pulp-making processes for virgin pulp. The pulp produced by the inventive system is a 100% post consumer paper pulp that is used to make recycled paper products. The inventive system also serves to reclaim 100% of the non-paper-based, non-food solid waste such as Styrofoam® food containers and plastic packaging, converting these materials into other commercially viable products such as new Styrofoam® cups, other Styrofoam® and plastic products, and fuel pellets. The inventive system produces zero waste going into a landfill and zero effluent water discharge, all under a minor source air permit.

By way of the present invention, post consumer solid waste materials from waste streams of, for example, fast food restaurants, casual dining restaurants, school and university cafeterias, stadium, arena and theme park concession stands, and the like, are collected. These solid waste materials fall into the following four general categories: (1) plastic-free and wax-free paper waste materials such as paper plates, paper napkins, paper cups, paper placemats, paper tablecloths, and paper bags; (2) plastic-coated paper waste materials such as plastic-coated paper cups, milk cartons, juice cartons, ice cream containers, and food packaging materials; (3) foam waste materials such as foam drinking cups, foam lids, and foam food containers; and (4) plastic waste materials such as plastic utensils, plastic cups and plates, plastic straws, lids, bottles and packaging materials. The post consumer solid waste materials also include a first organic waste material stream containing organic or food waste, sludge and raw wastewater. Those waste streams with degradable food-waste may be collected in a poly bag that can have a vacuum drawn on it to reduce microbial growth before transporting them

The collected post consumer solid waste materials are then sent to one or more locations for further processing. In an exemplary embodiment, which is best shown in the schematic process flow diagram of the FIGURE, the collected solid waste materials 10 are sent to a collection center or centralized location 12 for wrapping the waste materials. Here, the waste materials are baled and poly wrapped by wrapping the baled materials in a clear or printed polyethylene or polythene film. The film is fed from reels under and around the baled waste materials, the edges of the film brought together and heat sealed, and the top and bottom crop sealed to form a “pack”.

Once a designated quantity of post consumer solid waste material (e.g., approximately twenty-two (22) tons of waste material) has been collected, baled, and wrapped, the waste material “packs” are then forwarded to a chosen processing center 14, which effectuates an exemplary embodiment of the process and embodies an exemplary embodiment of the self-contained system of the present invention. Post Consumer solid waste material can also be delivered to the system in more conventional means, which also fall under the intent of this inventive system.

The inventive system is self-contained in that it does not require outside sources of electricity or natural gas, but available electricity and natural gas may be used if its lower pricing at that site supports selling more energy in different forms (e.g. diesel fuel or heavier oil products). Moreover, effluent water produced by the inventive system does not require treatment prior to discharge into municipal waterways. Further, the inventive system performs its operations within the limits of minor source air permitting.

In the exemplary embodiment shown in the FIGURE, the processing center or system 14 employs at least one server computer 16 that acts as a gateway for Internet access. The server computer(s) 16 is adapted to support a website that allows for remote access to the server computer(s) 16 by the collection center 12. Once the designated quantity of post consumer solid waste material has been collected, baled, and wrapped, the collection center 12 accesses the processing center website and arranges for pick-up and delivery to the processing center 14.

Upon arrival at the processing center 14, the “packs” are directed to one or more bale handlers 18 where the “packs” are broken and the contents forwarded to a multiple component sorting system 20. The sorting system 20 serves to separate the collected post consumer solid waste materials into one or more paper waste material streams 22, one or more foam waste material streams 24, one or more plastic waste material streams 26, and a first organic waste material stream 28 comprising organic waste, sludge, and raw wastewater.

The foam waste materials in the one or more foam waste material streams 24 are converted (or arrangements made for their conversion) into recycled foam products (e.g., recycled foam cups).

The paper waste materials in the one or more paper waste material streams 22 are weighed, shredded, soaked, washed (e.g., in a cleansing antibacterial bath), de-watered and then directed to a pulping apparatus (e.g., high-speed shearing device such as a hydro-pulper) 30 where paper is separated from undesirable inorganic materials, comminuted or disintegrated, and extracted from the pulping apparatus in slurry form. The slurry is then screened and decontaminated, subjected to additional operations serving to remove plastics and inks, to further clean and screen the slurry, and optionally, to enhance the qualities of the fibers contained within the slurry by adding a fiber-enhancing additive such as a hemi-cellulose additive available from Cargill, Incorporated, P.O. Box 9300, Minneapolis, Minn., product designation HEMIFORCE™ enhanced fiber additives For example, the slurry may be screened and decontaminated using a CONTAMINEX® or FIBERIZER™ pulper detrasher and ragger, then a drum screen, then a series of screens and cleaners, flotation and dewatering techniques, followed by either condensation using a wet lap fiber press or immediate conveyance to paper making machine 38, or a pulp drying machine. In addition, separated waste may be processed with a fine-bubble aeration system 31 (RAR: Recovery Aqua Resources system) to remove suspended solids and biological oxygen demand from the water for return to the system. Waste solids may be discharged to a rejects press for dewatering, while waste sludge may be dewatered with a sludge press. Materials from the rejects press and the sludge press would become part of a second organic waste material stream. The inventive system ultimately produces a brown and white paper pulp product stream for a range of tissue and paper products 32, a white paper pulp product stream for high recycle-containing beverage cups 34, and a second organic waste material stream 36 containing organic waste, plastic from the plastic-coated paper waste materials, sludge, inks, and raw wastewater, and separates these product streams.

The brown and white paper pulp produced by the inventive system may be described as a kraft fiber pulp that may be manufactured to various specifications.

The white paper pulp produced by the inventive system is a high quality FDA-approved white paper pulp that may be used to manufacture polyethylene-coated disposable articles for contact with beverages (i.e., beverages in the form of cold liquids or liquids at temperatures in excess of 150° F., beverages containing up to 8% of alcohol, nonalcoholic beverages, and beverages containing more than 8% of alcohol, see 21 C.F.R. 176.170(c)).

The product streams from the pulping apparatus 30 are then processed as described below, which can occur in a number of consecutive or simultaneous operations.

The brown and white paper pulp product stream 32 is directed to one or more machines (e.g., a swing paper-making and tissue paper-making machine that produces both retail and commercial grades) 38 for making 100% post consumer recycled paper products including jumbo (parent) rolls of paper and tissue-paper, paper napkins and paper towels, and for making tissue-paper products including facial tissue and bath tissue. These recycled paper products are unique in that they are made entirely from post consumer, food-bearing solid waste materials.

The white paper pulp product stream 34 in this exemplary embodiment is directed to one or more paper-making machines (e.g., white board paper-making machines) 40 for making FDA-approved (up to 40.0% post consumer recycled) paper products (e.g., poly coated drinking cups). These drinking cups may be used for both hot and cold, alcoholic and non-alcoholic beverages.

The one or more plastic waste material streams 26 and the first and second organic waste material streams 28, 36 are directed to a system for producing fuel pellets 42. Preferably, the fuel pellets that are produced by system 42 measure less than about 1 inch in length and have a moisture content of less than about 15%, however any dimension of fuel pellet can be handled by the system. The heat value or BTUs of the fuel pellets that are produced by this exemplary embodiment of the inventive system range in value from approximately 10,500 to approximately 16,000 BTUs. Different BTU level fuel pellets can be produced by adjusting the type and amount of waste material fed to the fuel pellet system 42. For example, lower BTU content waste material (e.g., packaging chaff, food waste particles, activated pulp sludge) can be mixed with higher BTU content waste material (e.g., plastic (including extracted plastic) and foam pieces) to produce a pellet of the desired BTU level.

A portion of the fuel pellets that are produced by the system are directed to a pyrolysis system with liquefaction zone 44, which produces carbon black or biochar, process gas, and synthetic diesel fuel. Two processes occur within pyrolysis system 44, a pyrolysis gasification process and a pyrolysis synthetic diesel process. The lower BTU (10,500-14,000 BTU) fuel pellets mentioned above are used for the pyrolysis gasification process, while the higher BTU (14,000-16,000⁺ BTU) fuel pellets are used for the pyrolysis synthetic diesel process. Remaining fuel pellets may be sold for use. In a preferred embodiment, the pyrolysis system 44 employs an air lock feed system, where pellets are introduced into air lock chambers in a consistent manner by a programmed pneumatic system, thereby allowing system 44 to produce energy with limited carbon dioxide (CO₂) emissions. As will be readily appreciated by those skilled in the art, the food portion of the food-bearing solid waste materials processed by the inventive system is totally consumed in pyrolysis system 44. As will also be readily appreciated, the ability to control size, moisture content, and BTU levels in the fuel pellets ensures a dependable and homogeneous feedstock supply for pyrolysis system 44, which serves to improve the system's performance.

At least a portion of the carbon black or biochar produced by the pyrolysis system 44 is directed back into the fuel pellet production system 42 where it is densified and then sold for use.

The process gas produced by pyrolysis system 44 may be used to power one or more gas-driven components (e.g., hoods, after dryers, paper and tissue paper-making machines, generators) of the self-contained system 14. The synthetic diesel fuel is used to power diesel fuel-driven components (e.g., generators), while generated electricity may be produced to power electric components of the inventive system 14.

Remaining portions of the process gas, the synthetic diesel fuel, heavy oils, lubricants and generated electricity may be sold for use.

Although the present invention has been shown and described with respect to detailed embodiments thereof, it will be understood by those skilled in the art that various changes in form and detail thereof may be made without departing from the spirit and scope of the claimed invention.

What is claimed is:

1. A waste reclamation process which takes 100% of the food-contaminated waste streams from various fast food-serving facilities or venues and converts them all into usable products and energy sources with zero effluent and zero landfill, supporting claims of 100% sustainability.

2. The process according to claim 1 which requires only water to operate. All other utilities (steam, power, hot air, etc.) are produced internally in an amount to make the to process self-sustaining.

3. The process according to claim 1 which takes any food-containing waste stream, sorts it and converts it to usable materials and energy sources with zero landfill and zero effluent.

4. The process according to claim 1 which takes waste streams from various fast food serving facilities or venues and converts the poly coated board fiber to paperboard that has been FDA approved for use to be used in beverage containers up to the 40% waste containing level.

5. The process according to claim 1 which controls and then eliminates bacteria from pickup through to processing of reclaimed food contaminated cups and the production of FDA approved cups containing 40% reclaimed fiber.

6. The process according to claim 1 which enhances fiber reclamation with a fiber-enhancing additive such as a hemi-cellulose additive available from Cargill, or similar additives in the waste recovery process.

7. The process according to claim 6 which utilizes fiber enhancing additives derived from corn, oats, wheat, soybeans, or other hemi-cellulose containing feedstocks.

8. The process according to claims 6 and 7 which improves both brown and white fiber freeness with said fiber-enhancing additive.

9. The process according to claim 1 which produces low sulfur fuels from food-contaminated waste streams.

10. The process according to claim 1 which utilizes Recovery Aqua Resources fine bubble technology to decrease biological oxygen demand and total suspended solids in the water system, permitting recycling 100% of the water in a closed loop system.

11. A 100% post-consumer fuel pellet system with steady programmed BTU content from low-density poly, high density poly, extracted cup carton poly, sludge food waste and packaging chafe.

12. The process according to claim 1, which produces bio char with minimal air emissions as one of the byproducts.
